(19) United States
(12) Patent Application Publication
(10) Pub. No.: US 2006/0229956 A1
(43) Pub. Date: Oct. 12, 2006

(54) Supplier financial health management process

(75) Inventors: F. Hobbs De Witt, Poughkeepsie, NY (US); Brenda C. Schmadeke, Raleigh, NC (US); Karyn Schneider, Baltimore, OH (US); Glenn G. Webb, Kyle, TX (US)

Correspondence Address: FLEIT, KAIN, GIBBONS, GUTMAN, BONGINI;& BIANCO P.L., ONE BOCA COMMERCE CENTER, 551 NORTHWEST 77TH STREET, SUITE 111, BOCA RATON, FL, 33487, US

(73) Assignee: INTERNATIONAL BUSINESS MACHINES CORPORATION, ARMONK, NY (US)

(21) Appl. No.: 11/099,712

(22) Filed: Apr. 6, 2005

(51) Int. Cl. G06Q 40/00

(52) U.S. Cl. 705/35

(57) ABSTRACT

A central information processing system and method evaluate financial health of a supplier of at least one of goods and services for a business entity, by determining that a supplier spend rate exceeds a predetermined level, determining a risk factor for the supplier based upon a financial health report and requesting at least one financial measurement of the supplier at a given period, wherein the period is based upon the risk factor. The risk factor is one of low, medium, and high risk. If the risk factor is low, the method requests the financial measurement on an annual basis. If the risk factor is medium or high, the method requests the financial measurement on a quarterly basis, determines if the supplier financial health has a high impact on the business entity, and initiates a mitigation plan to reduce a current quantity of purchase by the business entity from the supplier.

### CROSS-REFERENCE TO RELATED APPLICATIONS

The present patent application is related to co-pending and commonly owned U.S. patent application No. XX/XXX,XXX, Attorney Docket No. POU9200500024US1, entitled “System and Method for Evaluating Potential Suppliers,” filed on the same date with the present patent application, the entire teachings of which is hereby incorporated by reference.

### BACKGROUND OF THE INVENTION

1. Field of the Invention

This invention generally relates to the field of suppliers of goods and services to business entities and more particularly relates to a system and method to assess the financial health of corporate suppliers and prioritize evaluation of supplier reviews for a given business entity.

2. Description of Related Art

A typical manufacturing corporation, or other business entity—and particularly a large, global corporation—interacts with an enormous number of product and service suppliers. In order to reduce the business risk to the corporation in dealing with an individual supplier, it is necessary to analyze the financial health status of each supplier. Evaluating this risk can be quite cumbersome considering the amount of time and resources needed to ensure the needs of the corporation are met.

Considering that most major corporations may have thousands of suppliers interacting with various facilities located on a worldwide basis, supplier financial health evaluation can consume a staggering amount of corporate resources. For the best interests of the corporation, each supplier must be evaluated on a regular basis. However, not all suppliers are considered equal—each supplier plays a different role in the overall function of the business entity. Some suppliers are extremely important in that they supply very large quantities of goods or services that are used in a large number of products. Other suppliers may not be responsible for such large volumes of goods, but they may be crucial to the success of the company because they are the sole supplier of a very important component. Still other suppliers may serve only a very limited role in that there are other suppliers who could easily step into the place of that supplier in the event that the supplier was unable to adequately perform its duties.

Requiring all suppliers to be evaluated in the same manner, when each supplier serves a different function, is time-consuming and wasteful. When the business entity expends resources in monitoring small suppliers, it prevents these resources from pursuing larger endeavors such as suppliers more critical to the overall goals of the business. However, focusing almost exclusively on large suppliers runs the risk of not observing a potential problem from a smaller supplier.

Therefore a need exists to overcome the problems with the prior art as discussed above, and particularly for an integrated process for prioritizing reviews of suppliers of goods and services based on the needs of the business and the impact of the potential financial failure of the supplier on the business entity.

### SUMMARY OF THE INVENTION

According to a preferred embodiment of the present invention, a computing system and method evaluate the financial health of a supplier of at least one of goods and services for a business entity, by determining that a supplier spend rate exceeds a predetermined level, then determining a risk factor for the supplier based upon a financial health report, and requesting at least one financial measurement of the supplier at a given period, wherein the period is based upon the risk factor. The risk factor is one of a low risk, a medium risk, and a high risk.

If the risk factor is low, the method requests at least one financial measurement of the supplier on an annual basis. If the risk factor is medium or high risk, the method requests at least one financial measurement of the supplier on a quarterly basis, determines whether the financial health of the supplier has a high impact on the business entity, and initiates a mitigation plan to reduce the current quantity of purchase by the business entity from the supplier.

The mitigation plan contains information such as the supplier's name, a commodity family of the supplier, a total amount the business entity spends on the supplier annually, an amount spent for production purposes, a financial condition of the supplier, a risk exposure, at least one mitigating factor, a contingency plan, a revenue change to the business entity, a current cash position of the supplier, and an amount of revenue of the business entity that is at risk if the supplier fails.

If the risk factor is medium risk and the impact of the financial health of the supplier on the business entity is high, the method further measures the effectiveness of the mitigation plan as determined by metrics indicated in the mitigation plan, measures a financial indicator of the business entity in order to assess the scope of potential impact on the business entity, notifies development personnel and the supplier of potential impact, and initiates an alternate source analysis.

If the risk factor is high risk and the impact of the financial health of the supplier on the business entity is high, the method further measures a financial indicator of the business entity in order to assess the scope of potential impact on the business entity, notifies development personnel and the supplier of potential impact, requests at least one financial measurement of the supplier on a monthly basis, updates the mitigation plan depending upon a value of the requested at least one financial measurement of the supplier, initiates an alternate source analysis, and classifies the supplier as unapproved.

### BRIEF DESCRIPTION OF THE DRAWINGS

In the accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a block diagram illustrating a supplier financial health management (SFHM) system in accordance with an exemplary embodiment of the present invention.

FIG. 2 is an exemplary illustration of a screen shot from an exemplary web portal of the SFHM system of FIG. 1, in accordance with an exemplary embodiment of the present invention.

FIG. 3 is a more detailed block diagram illustrating a supplier financial health management server of the system of FIG. 1, in accordance with an exemplary embodiment of the present invention.

FIGS. 4, 5, 6, 7, 8, 9, 10, 11 and 12 are operational flow diagrams illustrating exemplary operational sequences for the system of FIG. 1, according to a preferred embodiment of the present invention.

### DESCRIPTION OF THE PREFERRED EMBODIMENTS

Terminology Overview

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms “a” or “an,” as used herein, are defined as “one or more than one.” The term “plurality,” as used herein, is defined as “two or more than two.” The term “another,” as used herein, is defined as “at least a second or more.” The terms “including” and/or “having,” as used herein, are defined as “comprising” (i.e., open language). The term “coupled,” as used herein, is defined as “connected, although not necessarily directly, and not necessarily mechanically.” The terms “program,” “software application,” and the like as used herein, are defined as “a sequence of instructions designed for execution on a computer system.” A program, computer program, or software application typically includes a subroutine, a function, a procedure, an object method, an object implementation, an executable application, an applet, a servlet, a source code, an object code, a shared library/dynamic load library and/or other sequence of instructions designed for execution on a computer system. The terms “corporation,” “business entity,” “partnership,” “company,” and “sole proprietorship” are used interchangeably to mean any entity transacting business.

Overview

The present invention, according to one embodiment, overcomes problems with the prior art by providing an integrated process for monitoring supplier financial health and initiating supplier relationships, and also provides an accessible repository for key information, with system and database interfaces to gain the efficiencies of a smooth flow of data. The system avoids redundancies in data storage and the expense of duplicate data requests by providing a portal by which potential suppliers approach a corporation, and strengthens weaknesses in supplier financial health assessment processes by creating a central repository and common process for a corporation's general procurement. The process encompasses new bid/new supplier activity as well as reviewing current suppliers on an outlined schedule. By determining supplier financial health, appropriate actions to manage risk are outlined and data is made available to the entire procurement community.

The core idea of an embodiment of the present invention is, firstly, a web portal for potential suppliers to approach a large corporation, be made aware of commodity descriptions and strategies, and to initiate the purchase of their financial health report at the supplier's own expense, which will be routed to appropriate procurement contact for consideration. Secondly, it contains an end to end process for managing financial health assessment of suppliers. The tool/business process satisfies audit and business control requirement as well as centralizing worldwide data.

An exemplary embodiment of the present invention provides a web front end portal that allows new potential suppliers to get a snap shot of corporate council descriptions and strategies as well as allows existing suppliers to renew financial health assessment on an annual basis. This efficient process contains a consistent means to assess potential new suppliers globally from a financial health perspective. An additional benefit of the new process is transferring the financial responsibility for purchase of a financial health report from the corporation to the supplier in most situations. Suppliers will absorb the minimal individual expense of their own report purchase, saving the corporation the tremendous expense of purchasing thousands of supplier financial health reports. By assessing financial health of suppliers, the risk to the corporation's revenue and client engagements is minimized.

Supplier Financial Health Management System

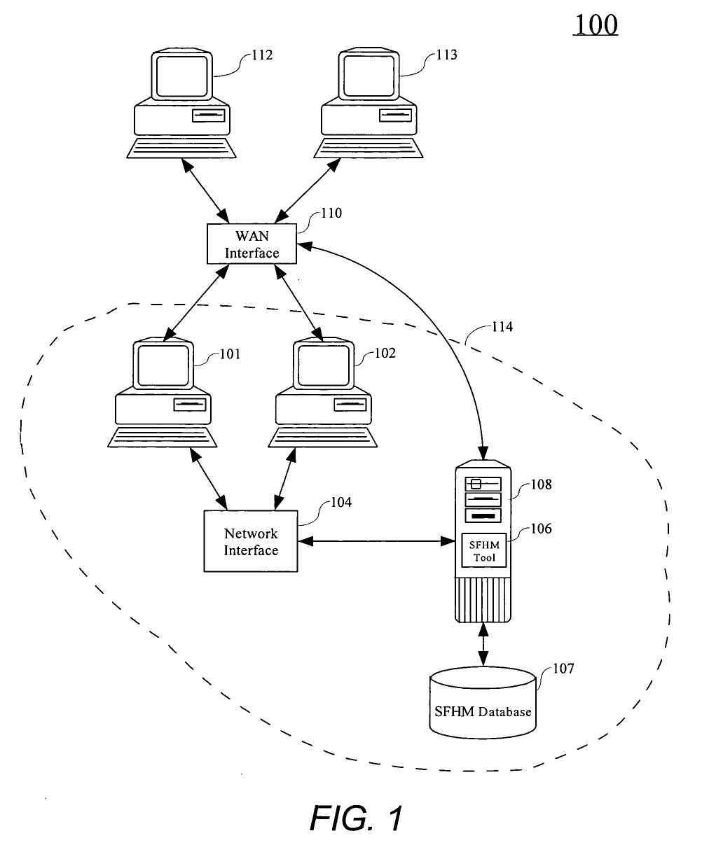

FIG. 1 illustrates an exemplary supplier financial health management (SFHM) system 100, or central information processing system, according to an embodiment of the present invention. Each SFHM system 100 includes, inter alia, one or more client information processing systems 101, 102, communicating via a local area network interface 104, a supplier financial health management server 108 containing a supplier financial health management tool 106, and a database (i.e. central repository) 107. The local area network interface 104 may be a wired communication link or a wireless communication link. Additionally, each client information processing system 101, 102 may also be communicatively coupled with a wide-area network 111 such as the Internet, through a wired, wireless, or combination of wired and wireless communication links via a wide area network communication link 110. The SFHM tool 106 and database 107, in the exemplary embodiment, are located on a remote server 108 of the local area network 114. The server 108 may alternately be located remotely on the wide-area network 111. Additionally, the SFHM tool 106 and database 107 may reside locally on one or more of the computer systems 101, 102. Finally, other client information processing systems 112, 113 are located remotely and communicate with the SFHM tool 106 via the wide-area network interface 110. The remote client information processing systems 112, 113 allow users outside the corporation, such as suppliers or potential suppliers, to have access to the SFHM tool 106.

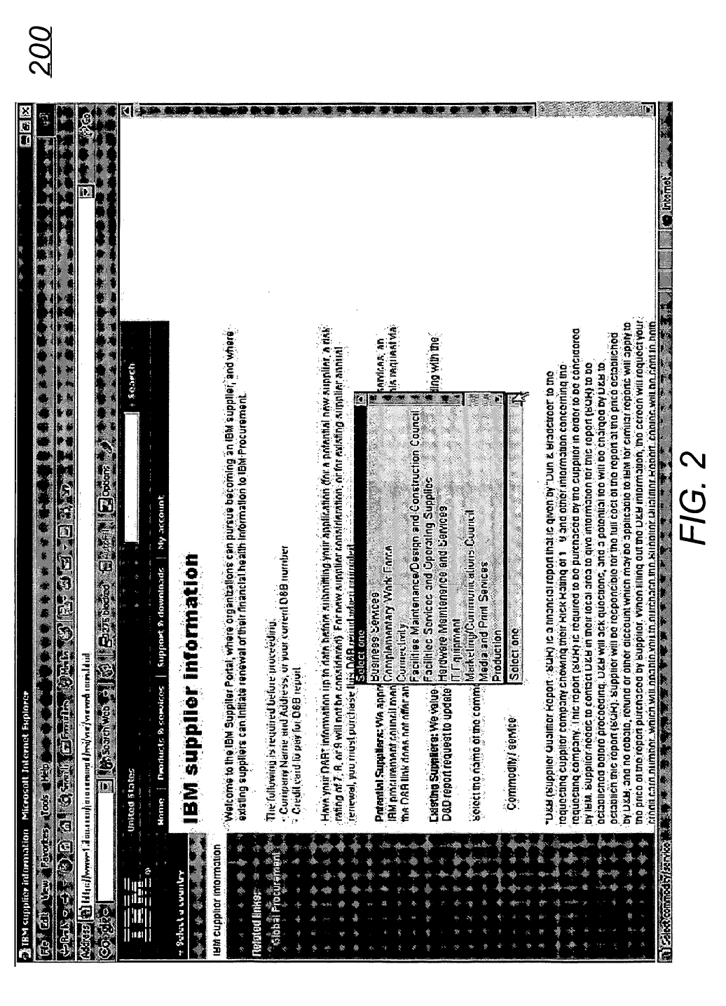

In an exemplary embodiment, the SFHM tool 106 is implemented as an html web portal, which is readily implemented as a link in the corporation's home web page—an example of which is shown in FIG. 2. This interface provides convenient, user-friendly access to information provided by the procurement community as well as step-by-step instructions for a new user or potential supplier to conveniently initiate the process for establishing a business relationship with the corporation.

Software and Computer Program Medium

In this document, the terms “computer program medium,” “computer-usable medium,” “machine-readable medium,” “computer program product” and “computer-readable medium” are used to generally refer to media such as non-volatile program memory 210, data memory 218, removable storage drive 220, a hard disk installed in hard disk drive (not shown), and signals. These computer program products are means for providing software to the client information processing system 101, 102. The computer-readable medium allows the client information processing system 101, 102 to read data, instructions, messages or message packets, and other computer-readable information from the computer-readable medium. The computer-readable medium, for example, may include non-volatile memory, such as floppy, ROM, flash memory, disk drive memory, CD-ROM, and other permanent storage. It is useful, for example, for transporting information, such as data and computer instructions, between computer systems. Furthermore, the computer-readable medium may comprise computer-readable information in a transitory state medium such as a network link and/or a network interface, including a wired network or a wireless network, that allow a computer to read such computer-readable information.

Various software embodiments are described in terms of this exemplary system. After reading this description, it will become apparent to a person of ordinary skill in the relevant art(s) how to implement the invention using other computer systems and/or computer architectures.

Supplier Financial Health Management Server

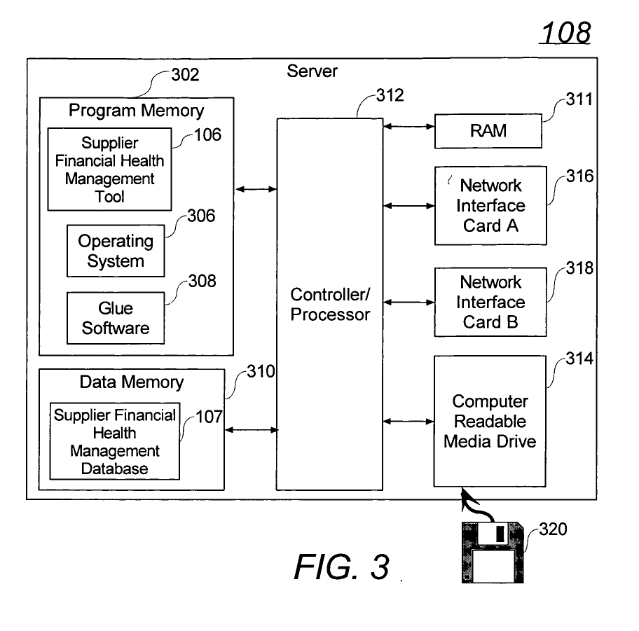

A more detailed block diagram of a supplier financial health management server 108 according to a preferred embodiment of the present invention is shown in FIG. 3. The server 108 includes one or more processors 312 which process instructions, perform calculations, and manage the flow of information through the server 108. The server 108 also includes a program memory 302, a data memory 310, and random access memory (RAM) 311. Additionally, the processor 312 is communicatively coupled with a computer readable media drive 314, network interface cards (NIC) 316 and 318, and the program memory 302. The network interface cards 316 and 318 may be wired or wireless interfaces.

Included within the program memory 302 are: a supplier financial health management tool 106, operating system platform 306, and resource management or glue software 308. The operating system platform 306 manages resources, such as the supplier financial health management database 107 and other information stored in data memory 310 and RAM 311, the scheduling of tasks, and processes the operation of the supplier financial health management tool 106 in the program memory 302. Additionally, the operating system platform 306 also manages many other basic tasks of the server 108 in a well-known manner.

Glue software 308 may include drivers, stacks, and low-level application programming interfaces (API's); it provides basic functional components for use by the operating system platform 306 and by compatible applications that run on the operating system platform 306 for managing communications with resources and processes in the server 108.

Supplier Financial Health Management Solution

An embodiment of the present invention consists of a process having a continuous flow of key supplier financial information. An exemplary embodiment of the process contains a standardized vehicle for any potential supplier to introduce themselves to the corporation. The process starts with a front end “Supplier On-Ramp” via the corporate web where potential suppliers can initiate the process to be considered as suppliers by the corporation. They are provided information to assess if or how their companies' services or products fit with the corporation's strategies. Then, if the user feels that the supplier's company is a good match or poses a significant likelihood that the corporation would be interested in conducting business with them, the user can then trigger a Dun and Bradstreet (D&B) report purchased at their own expense to be routed to the appropriate contact within the corporation for consideration for future business opportunities. This Supplier On-Ramp is also utilized by existing suppliers to purchase an updated D&B report to route to the corporation as part of an annual financial health assessment—a process which is described in more detail later, and which is required of suppliers for a continued business relationship.

It is important to note here that although the Dun & Bradstreet Supplier Evaluation Risk (SER) score is used as an exemplary reporting agency, it is within the scope of the present invention to use reports or scores generated by other credit reporting or financial health service reporting companies. Other exemplary reporting services include Moody's, Standard & Poor's, and Fitch. The SER provides information and analyses that can assist a corporation in assessing the risk of doing business with a particular supplier. The SER provides an objective, third-party opinion of potential suppliers.

Supplier On-Ramp Process

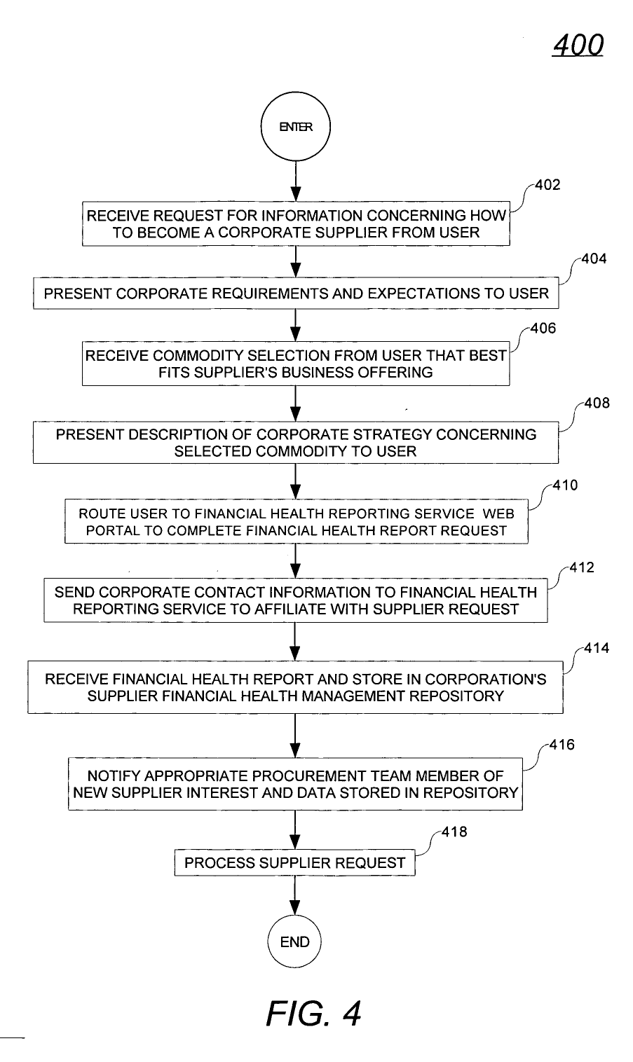

FIG. 4 is an exemplary operational flow diagram illustrating an overview of the steps performed during the “Supplier On-ramp” portion of the process. The method begins, at step 402, when the supplier financial health management tool 106 receives a request for information concerning instructions for becoming a corporate supplier from a potential supplier. In an exemplary embodiment, the potential supplier communicates this request to the supplier financial health management tool 106 from a web portal 200 which is accessed as easily as clicking on a link provided on an Internet site, such as the corporation's home web page. At step 404, the process presents the corporation's supplier requirements and expectations to the user. By presenting the corporation's requirements and expectations up front, the initial onus of deciding whether these requirements are agreeable to pursue a relationship further rests on the potential supplier. In this manner, companies that would have no possibility at all of developing this relationship are eliminated from consideration on their own initiative and the corporation is spared the cost, from both a dollars and time perspective, of ever expending resources on an endeavor that would never come to fruition.

If the potential supplier, after analyzing the corporation's requirements and expectations in light of what his company has to offer, feels that there is a strong likelihood that the corporation may be interested in pursuing a relationship with his company, then the user continues the process by selecting a commodity category from a pre-determined listing of commodity categories, that best describes the supplier's business offering. This request is received at the supplier financial health management tool 106 at step 406. After the commodity category is selected, the method provides a description of the corporation's strategy concerning the selected commodity to the user, at step 408. Again, at the wish of the user, he may choose to continue the initiation process, indicated in a manner such as clicking on a provided internet link, and is routed to a financial health reporting service web portal to complete the request for a Supplier Evaluation Risk score directly from the reporting service, at step 410. The appropriate information concerning whom to contact within the corporation for receipt of the report is sent to the financial health reporting service and associated with the potential supplier, at step 412.

It is important to note at this point that since the actual potential supplier is requesting the financial health report directly from the source, the cost of the report is endured by the supplier himself, not the corporation. Since this cost is minimal to the potential supplier, it is a price that most suppliers would willingly pay in order to form a productive relationship with a successful, established corporation. It is also a factor that the potential supplier must take into consideration when deciding whether or not to continue to pursue the relationship. However, for the corporation itself, if forced to purchase a financial health report for every potential supplier that vies for the opportunity to conduct business, which could be thousands of reports per year, the savings for shifting this cost burden will be very significant.

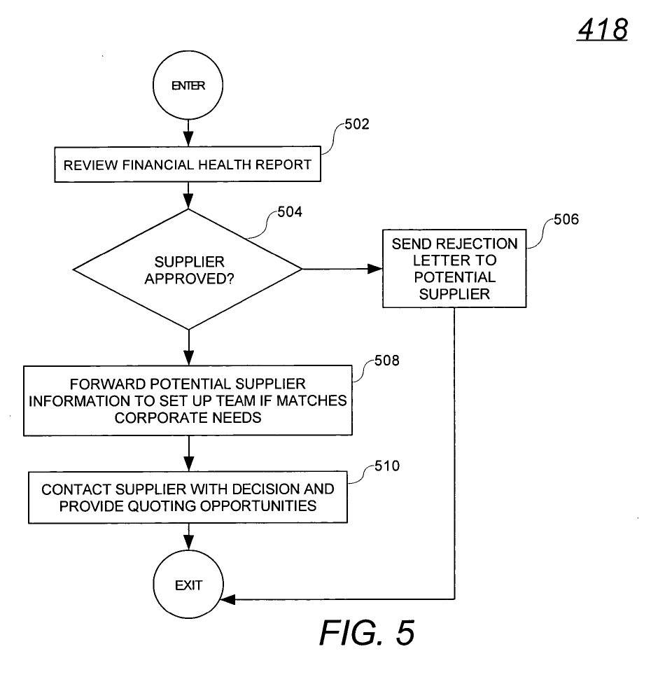

At step 414, the financial health report is received by both the corporation and the supplier itself, and stored in the corporation's supplier financial health management repository 107. The appropriate procurement team member is notified of the new supplier interest and the data (SER report) stored in the repository 107, at step 416. At step 418, which is described in detail in FIG. 5, the supplier request is processed.

Turning now to FIG. 5, after receiving the notification of a potential new supplier, the financial health report is reviewed, at step 502, and the procurement team member determines whether to pursue a relationship with the new supplier, at step 504. If it is not within the corporation's best interest to pursue the relationship at the present time (i.e. the potential supplier poses too high a risk or offers a product not presently needed), then a rejection letter is sent to the potential supplier, at step 506. However, if the potential supplier is approved (i.e. the potential supplier poses a low risk and matches corporate needs), the information concerning this supplier is sent to a supplier set-up team, at step 508, and the supplier is contacted with the decision to pursue and provide quoting opportunities, at step 510. A supplier posing “low risk” has a strong to extremely strong capacity to meet its financial commitment on an obligation. A supplier having a “medium risk” is more vulnerable to nonpayment of obligations, but currently has the capacity to meet its financial commitment on the obligation. However, adverse business, financial, or economic conditions will likely impair its capacity or willingness to meet its financial commitment. A “high risk” rating indicates the supplier is currently highly vulnerable to nonpayment or is actually in payment default.

Supplier Financial Health Management Data Repository

The second part of an exemplary embodiment of the present invention concerns accessing the data repository 107 for storage of supplier financial health reports and scores by procurement or other corporate personnel or agents, maintaining current data on existing suppliers, and keeping potential suppliers' reports on hand for future sourcing consideration. This process is implemented by updating the supplier financial health management tool 106 with current corporate commodity information and strategies, providing a secure link to Dun and Bradstreet for purchase of financial health reports by the supplier, and behind-the-scenes routing to the appropriate corporate procurement contact.

From time to time, certain corporate users may need to access reports contained in the supplier financial health management repository 107 or request updated reports. For example, in a global corporation, procurement personnel located in a different facility than the one making first contact with the supplier may have an opportunity to do additional business with that supplier and may need to access the supplier's financial health report before making the determination to continue. Additionally, the finances of all suppliers must be kept up-to-date and reviewed on a regular basis in order to minimize risk to the corporation. To evaluate each supplier, the corporation must have a current financial report. For certain requests, it is within the discretion of the corporation to require the supplier to pay the expense of acquiring the financial health report, while in other instances, it would be more appropriate for the corporation itself to bear this cost.

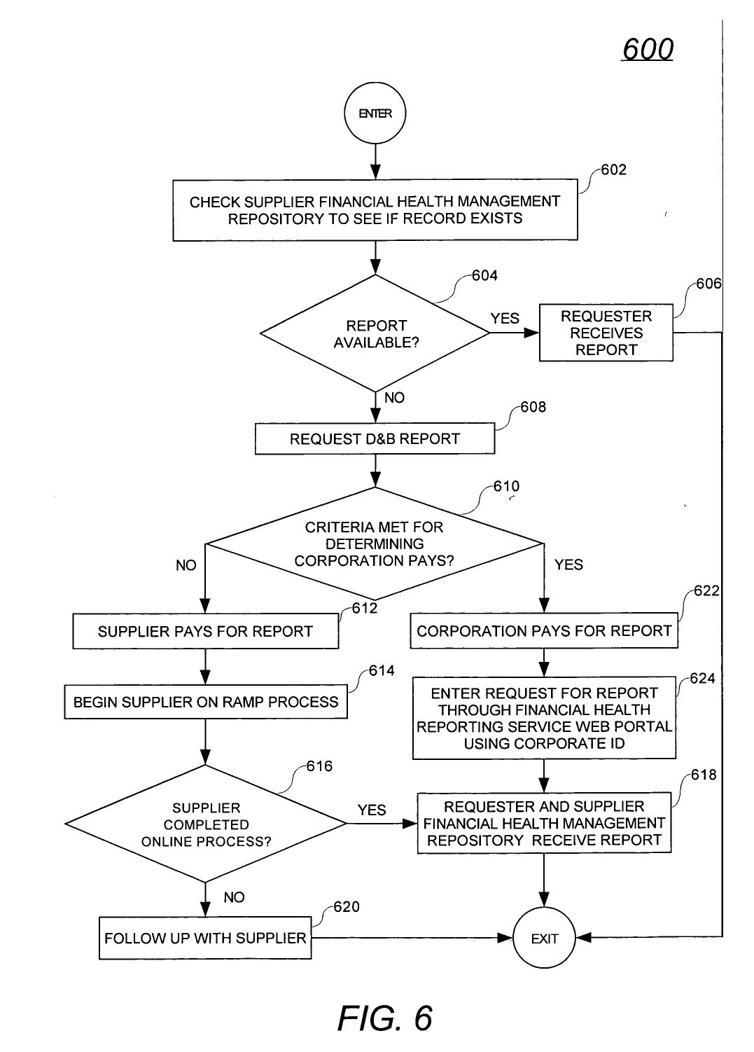

FIG. 6 depicts an exemplary process for reviewing the financial health of a corporate supplier. Beginning at step 602, the supplier financial health management repository 107 is checked to see if a current record exists. If a current report is available, at step 604, the requester receives the report, at step 606, and the process ends. However, if a current report does not exist, the report is requested, at step 608, using the web portal. At this point, the determination must be made to see which party, the corporation or the supplier, must incur the expense for the report. If certain pre-determined criteria are met (discussed below), at step 610, the corporation pays for the report, at step 622, and the request for the report is made through the financial health reporting service web portal, charging the expense to a corporate ID, at step 624. The requester and the supplier financial health management repository 107 receive copies of the SER report, at step 618, and the process ends. The criteria include such things as whether the supplier is due for a scheduled review, or whether the inquiry was customer directed. However, if the payment criteria are not met, at step 610, the supplier pays for the report, at step 614, and the supplier is instructed to complete the supplier on-ramp process detailed in FIG. 4, at step 614. As long as the supplier completes the online request process, at step 616, the requester and the supplier financial health management repository 107 receive a copy of the financial health report, at step 618. However, if the supplier does not complete the request process, at step 616, it is necessary for the corporation to contact the supplier to follow-up.

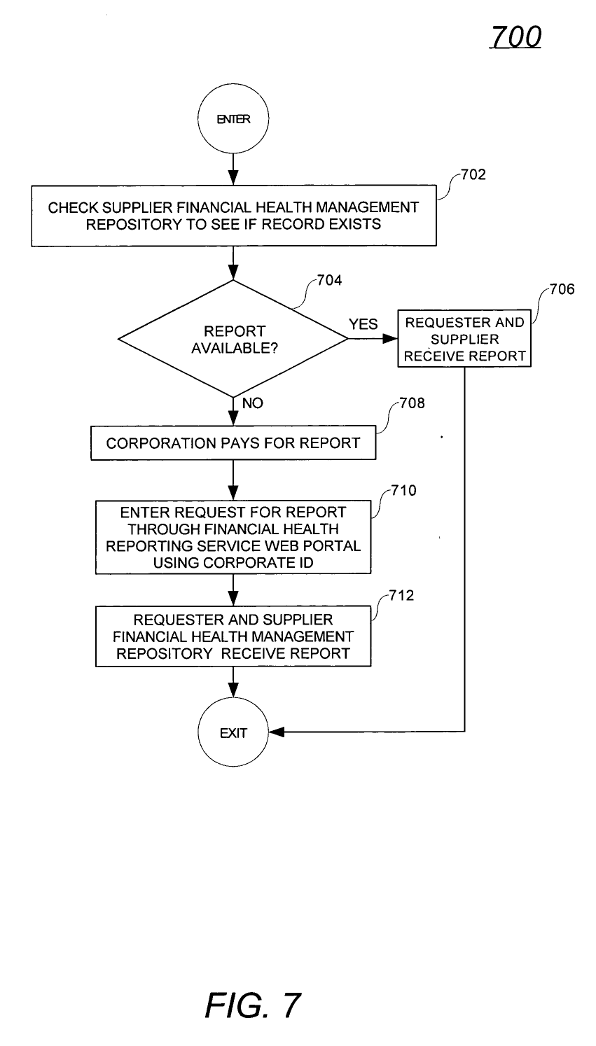

In other scenarios, such as when the corporation conducts financial reviews, when the person requesting the report is a potential supplier (as discussed above) or, when there is a dispute which requires the use of an ombudsman or arbitrator, there is no doubt that the corporation itself should incur the expense of obtaining the financial health report. FIG. 7 depicts an exemplary operational flow sequence occurring when the user is a member of a predetermined classification of users. Beginning at step 702, the supplier financial health management repository 107 is checked to see if a current record for the supplier exists. If a current report is available, at step 704, the requester receives the report, at step 706. However, if a current report is not available, the corporation pays for the report, at step 708, and the request for the report is made through the financial health reporting service web portal, charging the expense to a corporate ID, at step 710. The requester and the supplier financial health management repository 107 receive copies of the financial health report, at step 712, and the process ends.

Supplier Financial Health On-Going Review Process

The supplier financial health reports stored in the supplier financial health management repository 107 are not only essential in determining whether to pursue a business relation with a potential new supplier, they also play a key role in evaluating and monitoring existing suppliers. Because the financial status of suppliers is subject to change quite often, and sometimes quite dramatically, it is vital to the corporation to keep abreast of the financial health of all of its suppliers in order to make contingency plans in the event of troubled situations. An exemplary embodiment of the present invention includes a systematic and structured means of evaluating supplier financial health status. Actual impact to the corporation's business is used to prioritize and focus on key suppliers.

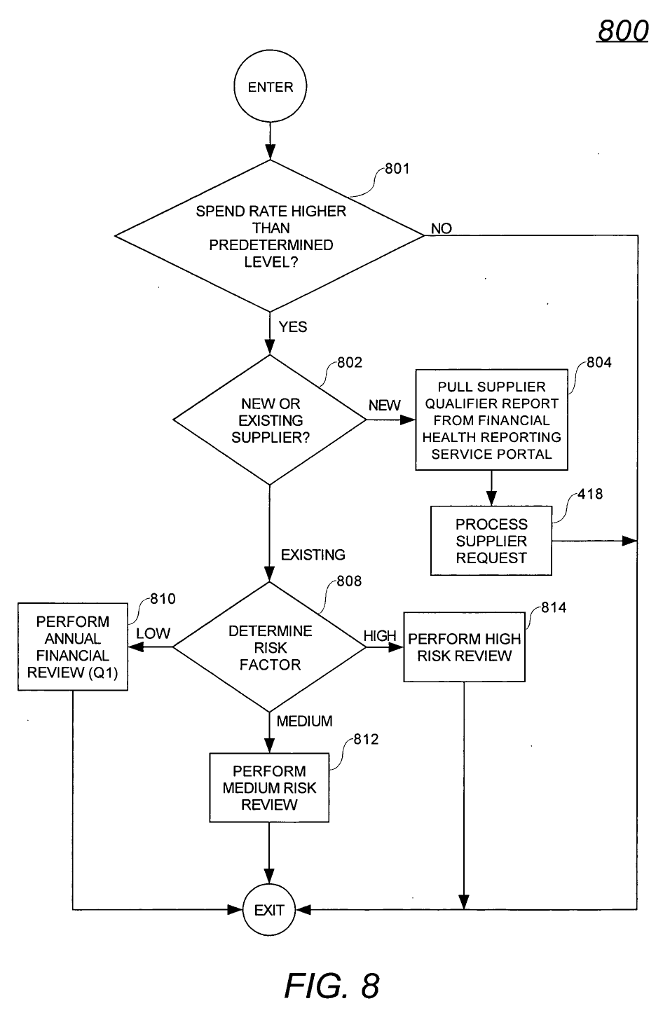

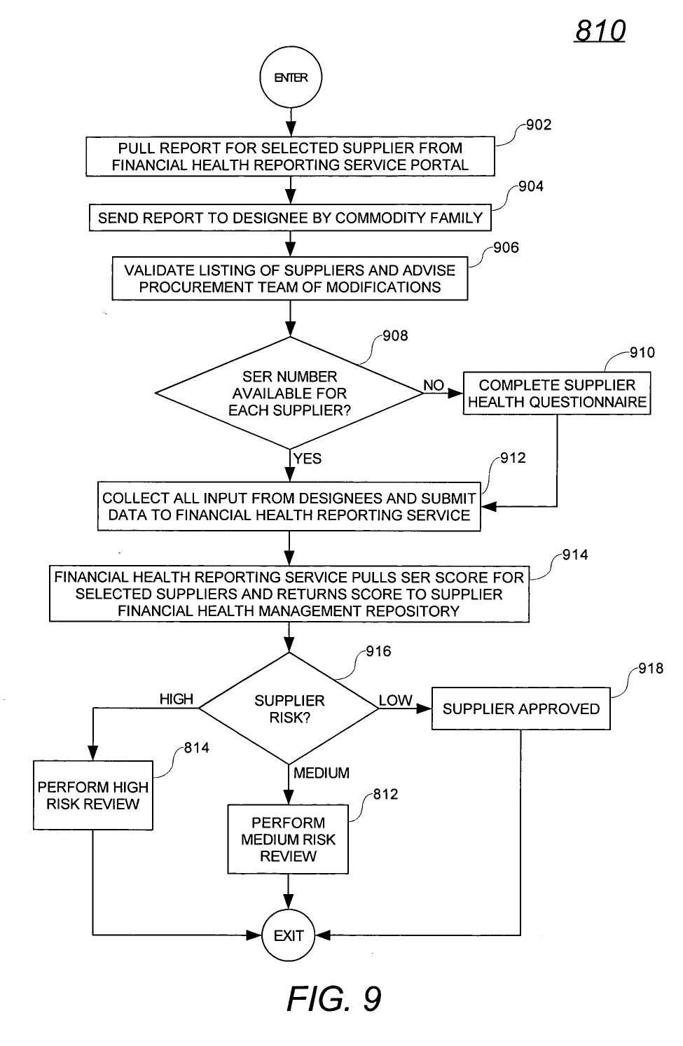

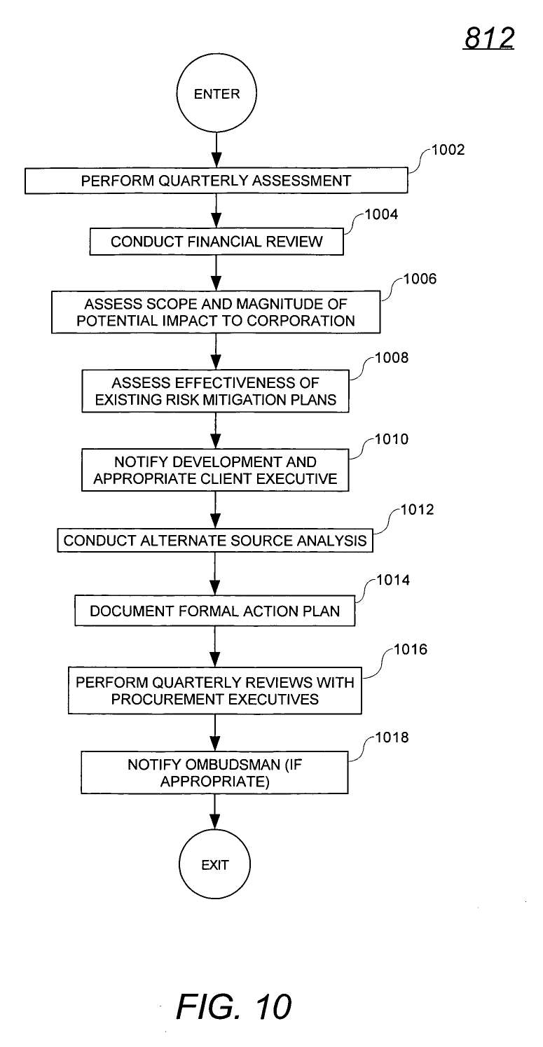

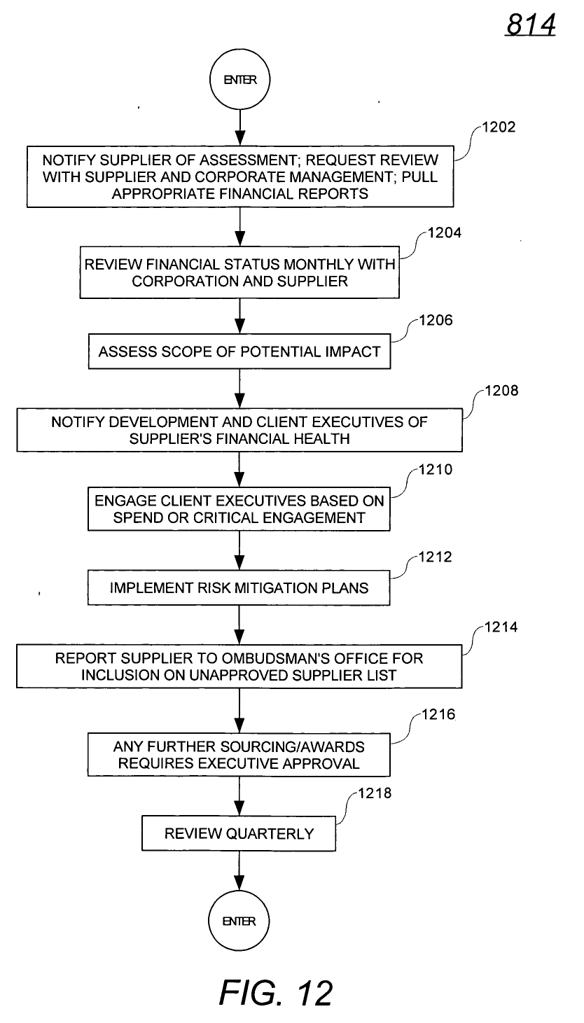

FIG. 8 depicts an overview of the entire exemplary process. Beginning at step 801, the method determines if the business entity spends more than a predetermined level of money on goods or supplies from that particular supplier each year. For suppliers with a spend rate below this level, it is not cost effective to spend the time or resources to evaluate the financial health of the supplier because the overall impact on the business is too low. For very large entities, this level could approach the million dollar level, but for smaller companies, this level would be closer to the hundreds or thousands of dollars. At step 802, the method determines if the supplier is a new supplier or an existing supplier. If the supplier is new, the supplier evaluation risk score is pulled from the supplier financial health management repository 107, at step 804, and the request is processed, at step 418, as shown in FIG. 5 and discussed previously. If the supplier is an existing supplier, at step 802, then the risk factor associated with that supplier is determined from a prior financial health report, at step 806. For example, a “Low Risk” supplier may have a D&B rating of 1, 2, 3 or 4, which indicates an historical probability of failure of less than 0.2%. These companies exhibit no issues or concerns with regard to financial standing or supply continuity. A “Medium Risk” supplier may have a D&B rating of 5 or 6, indicating an historical probability of failure of less than 3%. These companies have no imminent danger of financial difficulties but some level of concern which may necessitate implementing mitigating actions. By contrast, a “High Risk” supplier may have a D&B score of 7, 8 or 9, which indicates an historical failure rate that may be greater than 21%! These companies have current issues or serious risk of near term financial difficulties. If the risk factor associated with the supplier, at step 808, is low, the only action needed is to perform an annual review, at step 810, which is depicted in FIG. 9 and will be described in greater detail later. If the risk factor, at step 808, is medium, it is necessary to perform a medium risk review, at step 812, which is detailed in FIG. 10, and if the risk is high, then at high risk review is performed, at step 814, which is illustrated by FIG. 12. Both the medium risk review and the high risk review will be discussed in greater detail.

Annual Review

An exemplary embodiment of the present invention performs a routine review of selected suppliers on an annual basis. Depending upon the role of the supplier in the corporate scheme and its impact to the corporation, the supplier may be routinely reviewed on a more or less frequent basis. For example, in the exemplary embodiment, the corporation reviews 100% of its core suppliers on an annual basis, but audits a lower percentage of its regional or niche suppliers or suppliers with a low annual cost. FIG. 9 illustrates an exemplary operational sequence for the annual review process. Beginning at step 902, the supplier financial health report for the selected supplier is pulled from the financial health reporting service portal in the manner depicted in FIG. 6 and described in detail above. Next, the report is sent to a designee assigned to evaluate the supplier according to commodity family, at step 904.

The designee validates the listing of suppliers and provides input back to the procurement team with any deletions/additions of suppliers and their corresponding SER number, at step 906. However, for a supplier that has had a very small impact on the overall corporation, such as one with a very small spend rate, it is likely that supplier will not be required to go through the formal process of acquiring a financial health report and therefore, will not have an allocated SER number. If the supplier does not have a SER number then the designee completes a Supplier Health Questionnaire, at step 910. An exemplary Supplier Health Questionnaire provides a manner to create a risk score that can be used as a substitute for the SER score. For example, the supplier is evaluated on a “Yes” or “No” basis in the following ten categories:
Financial concerns within the prior year
Actively sub-tiers corporate engagements (for Tech & Bus Services)
Decreasing profits over 3 years
No forty-five day payment terms
Client/buyer escalations
Aged Accounts Payable
Aged Accounts Receivable
Poor Supplier Performance Report
Invoicing issues
Privately held
   Each category receiving a “Yes” answer is assigned a value of 1, and each category receiving a “No” answer is assigned a value of 0. If the total score is three or less, the supplier is considered “low risk,” for a total score of four, five or six, the supplier is considered “medium risk,” and any score above six is considered “high risk.”

Next, all the input for each supplier is collected and submitted to a financial health reporting service, at step 912. A Supplier Evaluation Risk Score (SER) is pulled for each selected supplier, at step 914, and the report is returned to the supplier financial health management repository 107. The SER scores are reviewed and action is taken for each supplier depending upon its associated risk factor, at step 916. If the risk factor is “Low,” then the supplier is approved and no further action will be taken regarding this supplier until its next regularly scheduled review period (usually an annual review). If the risk factor is “Medium,” then a medium risk review is performed, at step 812, which is detailed in FIG. 10 and will be discussed in greater detail later. For a “High” risk factor, a high risk review is performed, at step 814, which is illustrated in FIG. 12 and will also be discussed in greater detail later.

Medium Risk Review

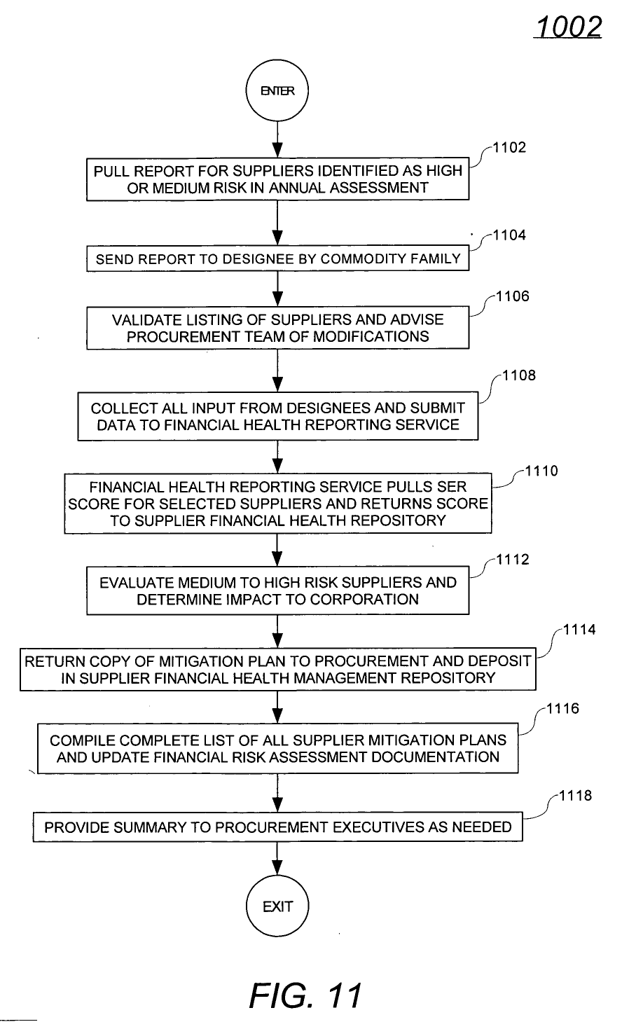

For suppliers identified as posing a “medium risk” to the corporation, the process illustrated in FIG. 10 is performed. Beginning at step 1002, the supplier is assigned to a quarterly review plan, which is performed according to the steps detailed in FIG. 11. Next, a financial review of the supplier is conducted, at step 1004. The scope and magnitude of the potential impact to the corporation is assessed, at step 1006. Factors to be considered in determining an impact value include:
Would there be a significant impact on the following:
   Cost increases?
   Service disruptions?
   Customer satisfaction
The relationship the corporation has with the supplier as a customer.
Would there be a lengthy transition time to a new supplier?

Next, the effectiveness of any existing risk mitigation plans is assessed, at step 1008, by way of measuring certain metrics indicated in the mitigation plan. Next, a notification is sent to development personnel and any appropriate client executive or product manager, at step 1010. The client executive is notified only if necessary, depending upon the supplier's spend rate or if it is a critical engagement. An alternate source analysis is conducted, at step 1012, to provide a backup plan in the event the supplier is unable to fulfill his commitments. A formal action plan is documented, at step 1014, and quarterly reviews with appropriate corporate executives, such as Procurement or Production executives, are performed, at step 1016. Finally, if it seems necessary to involve an objective, third party, an Ombudsman is notified of the current situation, at step 1018.

Quarterly Reviews

A quarterly review, as illustrated in FIG. 11, is a more detailed and extensive evaluation than the annual review and is performed in the three fiscal year quarters in which an annual review is not performed. Beginning at step 1102, the supplier financial health report for all suppliers identified as high or medium risk in the annual review is pulled from the financial health reporting service portal in the manner depicted in FIG. 6 and described in detail previously. Next, the report is sent to a designee assigned to evaluate the supplier according to commodity family, at step 1104. The designee validates the listing of suppliers and provides input back to the procurement team with any deletions/additions of suppliers and their corresponding SER Number, at step 1106. Next, all the input for each selected supplier is collected and submitted to the financial health reporting service, at step 1108. A Supplier Evaluation Risk Score (SER) is pulled for each selected supplier, at step 1110, and the report is returned to the supplier financial health management repository 107. Those suppliers that are medium to high risk are evaluated and their impact to the corporation is determined, at step 1112. If there is a high impact to the corporation's business, then further investigation is required as outlined in the “Medium Review” process of FIG. 10, and a formal mitigation plan is created, as described below. If the impact to the corporation is low, then a basic mitigation plan is provided.

An exemplary mitigation plan includes information such as the supplier's name, the commodity family of the supplier, the total amount the corporation spends on the supplier annually, the amount spent for production purposes, the supplier's financial situation, risk exposure, any mitigating factors, contingency plan(s), the impact on the corporation's revenue, the supplier's current cash position, and the corporation's revenue that is at risk if the supplier fails (goes bankrupt or shuts down).

A complete list of all supplier mitigation plans and updated Financial Risk Assessment documentation is compiled, at step 1116. Finally, a summary is provided to procurement executives as needed, at step 1118.

High Risk Review

For suppliers that are determined to be at high risk, immediate action must be taken, according to an exemplary process presented in FIG. 12. Beginning at step 1202, the supplier is notified supplier of the assessment, a review is requested with the supplier and a corporate management team, and appropriate financial reports including a comprehensive report from a financial health reporting service are pulled. The financial status of the supplier is reviewed on a regular monthly interval between the corporation and the supplier, at step 1204. The scope of potential impact (such as which products are affected, time, and customer engagement) is assessed, at step 1206. Development and client executives are notified of supplier's financial health, at step 1208. Client executives are engaged based on spend rates or critical supplier engagement (e.g. supplier is sole supplier of necessary product), at step 1210. Risk mitigation plans are immediately implemented, at step 1212, which may include, but not limited to the following:
Redirection of sourcing to qualified supplier
Qualification of new source, if not single/sole source
Ceasing further Request For Quote/Request For Proposal activity
Purchasing total requirements for supplier
   The supplier is reported to an Ombudsman's office for inclusion on an Unapproved Supplier List, at step 1214. Any further sourcing/awards requires executive approval, at step 1216. Finally, the supplier is reviewed quarterly to determine the effectiveness of mitigation plans and the current financial outlook.

Non Limiting Hardware and Software Examples

The present invention can be realized in hardware, software, or a combination of hardware and software. A system according to a preferred embodiment of the present invention can be realized in a centralized fashion in one computer system or in a distributed fashion where different elements are spread across several interconnected computer systems. Any kind of computer system—or other apparatus adapted for carrying out the methods described herein—is suited. A typical combination of hardware and software could be a general-purpose computer system with a computer program that, when being loaded and executed, controls the computer system such that it carries out the methods described herein.

The present invention can also be embedded in a computer program product, which comprises all the features enabling the implementation of the methods described herein, and which—when loaded in a computer system—is able to carry out these methods. Computer program means or computer program in the present context mean any expression, in any language, code or notation, of a set of instructions intended to cause a system having an information processing capability to perform a particular function either directly or after either or both of the following a) conversion to another language, code or, notation; and b) reproduction in a different material form.

A computer system may include, inter alia, one or more computers and at least a computer readable medium, allowing a computer system, to read data, instructions, messages or message packets, and other computer readable information from the computer readable medium. The computer readable medium may include non-volatile memory, such as ROM, Flash memory, Disk drive memory, CD-ROM, and other permanent storage. Additionally, a computer readable medium may include, for example, volatile storage such as RAM, buffers, cache memory, and network circuits. Furthermore, the computer readable medium may comprise computer readable information in a transitory state medium such as a network link and/or a network interface, including a wired network or a wireless network that allow a computer system to read such computer readable information.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A method on a central information processing system for evaluating financial health of a supplier of at least one of goods and services for a business entity, the method comprising:
determining that a spend rate for the supplier exceeds a predetermined level;
determining a risk factor for the supplier based upon a financial health report;
requesting at least one financial measurement of the supplier at a given period, wherein the period is based upon the risk factor.

2. The method of claim 1, wherein the risk factor comprises at least one of a low risk, a medium risk, and a high risk.

3. The method of claim 2, wherein in response to the risk factor determined to be low risk, further comprising:
requesting at least one financial measurement of the supplier on an annual basis.

4. The method of claim 2, wherein in response to the risk factor determined to be one of medium risk and high risk, further comprising:
requesting at least one financial measurement of the supplier on a quarterly basis;
determining whether a financial health of the supplier has a high impact on the business entity; and
initiating a mitigation plan to reduce a current quantity of purchase by the business entity from the supplier.

5. The method of claim 4, wherein the mitigation plan comprises at least one of a name of the supplier, a commodity family of the supplier, a total amount the business entity spends on the supplier annually, an amount spent for production purposes, a financial condition of the supplier, a risk exposure, a mitigating factor, a contingency plan, a revenue change to the business entity, a current cash position of the supplier, and an amount of revenue of the business entity that is at risk if the supplier fails.

6. The method of claim 4, wherein in response to the risk factor determined to be medium risk and the impact of the financial health of the supplier on the business entity determined to be high, further comprising:
measuring an effectiveness of the mitigation plan as determined by metrics indicated in the mitigation plan;
measuring a financial indicator of the business entity in order to assess the scope of potential impact on the business entity;
notifying development personnel and the supplier of potential impact; and
initiating an alternate source analysis.

7. The method of claim 4, wherein in response to the risk factor determined to be high risk and the impact of the financial health of the supplier on the business entity determined to be high, further comprising:
measuring a financial indicator of the business entity in order to assess the scope of potential impact on the business entity;
notifying development personnel and the supplier of potential impact;
requesting at least one financial measurement of the supplier on a monthly basis;
updating the mitigation plan depending upon a value of the requested at least one financial measurement of the supplier;
initiating an alternate source analysis; and
classifying the supplier as unapproved.

8. A computer program product for evaluating financial health of a supplier of at least one of goods and services for a business entity, the computer program product comprising computer instructions for:
determining that a spend rate for the supplier exceeds a predetermined level;
determining a risk factor for the supplier based upon a financial health report;
requesting at least one financial measurement of the supplier at a given period, wherein the period is based upon the risk factor.

9. The computer program product of claim 8, wherein the risk factor comprises at least one of a low risk, a medium risk, and a high risk.

10. The computer program product of claim 9, wherein in response to the risk factor determined to be low risk, further comprising instructions for:
requesting at least one financial measurement of the supplier on an annual basis.

11. The computer program product of claim 9, wherein in response to the risk factor determined to be one of medium risk and high risk, further comprising instructions for:
requesting at least one financial measurement of the supplier on a quarterly basis;
determining whether the financial health of the supplier has a high impact on the business entity; and
initiating a mitigation plan to reduce a current quantity of purchase by the business entity from the supplier.

12. The computer program product of claim 11, wherein the mitigation plan comprises at least one of a name of the supplier, a commodity family of the supplier, a total amount the business entity spends on the supplier annually, an amount spent for production purposes, a financial condition of the supplier, a risk exposure, a mitigating factor, a contingency plan, a revenue change to the business entity, a current cash position of the supplier, and an amount of revenue of the business entity that is at risk if the supplier fails.

13. The computer program product of claim 11, wherein in response to the risk factor determined to be medium risk and the impact of the financial health of the supplier on the business entity determined to be high, further comprising instructions for:
measuring an effectiveness of the mitigation plan as determined by metrics indicated in the mitigation plan;
measuring a financial indicator of the business entity in order to assess the scope of potential impact on the business entity;
notifying development personnel and the supplier of potential impact; and
initiating an alternate source analysis.

14. The computer program product of claim 11, wherein in response to the risk factor determined to be high risk and the impact of the financial health of the supplier on the business entity determined to be high, further comprising instructions for:
measuring a financial indicator of the business entity in order to assess the scope of potential impact on the business entity;
notifying development personnel and the supplier of potential impact;
requesting at least one financial measurement of the supplier on a monthly basis;
updating the mitigation plan depending upon a value of the requested at least one financial measurement of the supplier;
initiating an alternate source analysis; and
classifying the supplier as unapproved.

15. A central information processing system for evaluating financial health of a supplier of at least one of goods and services for a business entity, the system comprising:
means for determining that a spend rate for the supplier exceeds a predetermined level;
means for determining a risk factor for the supplier based upon a financial health report;
means for requesting at least one financial measurement of the supplier at a given period, wherein the period is based upon the risk factor.

16. The system of claim 15, wherein the risk factor comprises at least one of a low risk, a medium risk, and a high risk.

17. The system of claim 16, wherein in response to the risk factor determined to be low risk, further comprising:
means for requesting at least one financial measurement of the supplier on an annual basis.

18. The system of claim 16, wherein in response to the risk factor determined to be one of medium risk and high risk, further comprising:
means for requesting at least one financial measurement of the supplier on a quarterly basis;
means for determining whether the financial health of the supplier has a high impact on the business entity; and
means for initiating a mitigation plan to reduce a current quantity of purchase by the business entity from the supplier.

19. The system of claim 18, wherein in response to the risk factor determined to be medium risk and the impact of the financial health of the supplier on the business entity determined to be high, further comprising:
means for measuring an effectiveness of the mitigation plan as determined by metrics indicated in the mitigation plan;
means for measuring a financial indicator of the business entity in order to assess the scope of potential impact on the business entity;
means for notifying development personnel and the supplier of potential impact; and
means for initiating an alternate source analysis.

20. The system of claim 18, wherein in response to the risk factor determined to be high risk and the impact of the financial health of the supplier on the business entity determined to be high, further comprising:
means for measuring a financial indicator of the business entity in order to assess the scope of potential impact on the business entity;
means for notifying development personnel and the supplier of potential impact;
means for requesting at least one financial measurement of the supplier on a monthly basis;
means for updating the mitigation plan depending upon a value of the requested at least one financial measurement of the supplier;
means for initiating an alternate source analysis; and
means for classifying the supplier as unapproved.
